(19) United States
(12) Patent Application Publication
(10) Pub. No.: US 2004/0118031 A1
(43) Pub. Date: Jun. 24, 2004

(54) Fishing rod holder

(76) Inventor: Glenn Alan Nielson, Kaysville, UT (US)

Correspondence Address: David B. Dellenbach, WORKMAN, NYDEGGER & SEELEY, 1000 Eagle Gate Tower, 60 East South Temple, Salt Lake City, UT, 84111, US

(21) Appl. No.: 10/328,348

(22) Filed: Dec. 23, 2002

(51) Int. Cl. A01K 97/10

(52) U.S. Cl. 43/21.2

(57) ABSTRACT

A fishing rod holder comprises (i) a base, (ii) a first upstanding member pivotally coupled to the base; and (iii) a second upstanding member pivotally coupled to the base such that an angler can place a fishing rod onto the first and second members, then readily remove the fishing rod from the upstanding members when a fish strikes a fishing line coupled to the fishing rod.

### BACKGROUND OF THE INVENTION

1. The Field of the Invention

This invention is in the field of fishing equipment. More specifically, this invention is in the field of fishing rod holders.

2. The Relevant Technology

In primitive times angling was used as a method for obtaining food. In more recent times, angling has evolved into both a sport and has remained a major food source in countries throughout the world. A variety of different types of angling are available such as deep sea fishing, fly fishing, spinner fishing, bait fishing and ice fishing. Each of these different kinds of angling has its own separate benefits and challenges.

Ice fishing presents a variety of different challenges associated with an angler standing on a sheet of ice attempting to catch a fish while dangling a lure (e.g., a jig, spinner, hook with bait thereon or fly) through a hole in the ice. Among the challenges faced by the ice fishing angler include the extreme weather conditions that the angler must fish in. The ice is required to be frozen in order for the angler to step thereon. The angler must also face the challenge of possible snow on the ice, cracks in the ice and the difficulty of keeping warm while attempting to fish on the ice. These in challenges are all in addition to the typical challenges involved with angling such as lure selection, achieving the proper depth of one's line, finding the appropriate place on a lake or frozen river where the fish are inclined to group and feed, holding the rod in a proper manner so as to be ready when a fish strikes to set the hook, and watching for signs of a strike such as by watching for movement in the tip of the rod.

One device that has been used in order to assist the angler in confronting these challenges is a rod holder. After setting a rod in a rod holder, an angler can warm his or her hands by a fire or stove or eat or drink in order to keep warm. However, typical rod holders surround the handle of a fishing rod, requiring the rod to be removed from these handles in order to move the rod quickly away from the fishing hole in order to set the hook. One difficulty with such existing typical fishing rod holding systems, such as rod holders comprising a tube or a wire that receives the rod handle therein is that it is often difficult to pull the rod out of such rod holders immediately upon detecting a strike by a fish.

Strikes can often be very subtle. Hesitation, which can occur when it is difficult to remove a rod from a rod holder, can cost an angler a long awaited catch and often does. The angler who exerts a great deal of time, money and patience to await the few strikes that may come on a particular day tends to be very disappointed when he or she loses a fish because of difficulty with equipment.

It would therefore be an improvement in the art to develop a rod holder that enables an angler to quickly disengage a fishing rod from the rod holder as soon as a strike is detected.

Since anglers must often carry their equipment to and from a vehicle, boat, or in the case of an ice fisherman, a frozen lake or river, it would be an improvement in the art to develop a fishing rod that is compact and convenient to store, use and transport.

### BRIEF SUMMARY OF THE INVENTION

Therefore, an object of the invention is to provide a fishing rod holder that allows convenient disengagement of a fishing rod from the rod holder.

It is another object of the invention to provide a fishing rod holder that is collapsible and compact.

It is another object of the invention to provide a fishing rod holder that is convenient to assemble.

It is another object of the invention to provide a fishing rod holder that does not grasp the handle of the fishing pole but instead allows convenient disengagement of the fishing pole from the fishing rod holder.

It is another object of the invention to provide a fishing rod holder that can be conveniently placed on and removed from a slippery surface such as ice.

The present invention relates to a fishing rod holder that allows a fishing rod to be conveniently disengaged therefrom. The fishing rod holder allows the fishing rod to be placed vertically downwardly onto the fishing rod holder and removed vertically upwardly therefrom without having to disengage the handle from a cumbersome mechanism.

In a preferred embodiment, the fishing rod holder comprises a horizontally oriented base member (e.g, in the form of an elongate plate) and first and second adjustable upstanding members (e.g., each in the form of an elongate plate) pivotally coupled thereto.

Coupled to the base member in a preferred embodiment are first and second horizontal stabilizing members e.g., on the rear end of the base member. The front and/or rear end of the base member may have a mechanism thereon which is configured to grasp a slippery surface such as ice. Examples of such a mechanism may include first and/or second spikes located on the front end and/or rear end of the base.

The upstanding members and horizontal stabilizing members are each preferably pivotally coupled to the base such that the members can be selectively moved between an operational position and a compact storage position.

In one embodiment, on the inside surface of at least one of the upstanding members, a slit is formed such that an eyelet (through which fishing line extends) of the fishing rod can be placed in the slit. The slit may extend all the way through the member or merely be made in one surface of the member and is sufficiently large to receive a portion of the eyelet therein.

The pivotal coupling of the upstanding members is preferably performed through the use of self-closing, position-retaining hinges (e.g., cabinet hinges) or another mechanism that retains a desired position of an upstanding member until a certain angle is reached, such that the upstanding members can (i) generally be angled at a desired position and retain a rod holder thereon without collapsing downward under their own weight or the weight of the rod; but (ii) self close upon being moved to a desired angle with respect to the base. Thus, in one embodiment the upstanding members are pivotally coupled to the base member in such a manner that the members snap down into a storage position upon being moved to a desired angle with respect to the base and can be oriented and retained at a desired angle that is convenient for placing a fishing rod thereon. The closed hinges are biased in the closed position upon being moved past the angle of closing.

Since the rod holder has a convenient operational position and a convenient compact position, the device can be readily stored, transported and used. The rod holder may be rested on the ice surface to enable the angler to engage in fishing while simultaneously eating, warming himself or herself by a fire or merely concentrating on any possible movement of the tip of the rod which could signal a strike by a fish. Upon receiving such a strike, the angler can readily grasp the rod from the rod holder, set the hook and catch the fish without having to disengage a handle from the rod holder.

The hinges connecting the upstanding members to the base member may prevent the fishing rod from merely pulling the members over when a strike occurs. For larger fish, the hinges may be stiffer to prevent them from being pulled over. Optionally, a lanyard may be coupled between the fishing rod and the ice and/or the rod holder to thereby prevent the fishing rod from being pulled into the water.

The fishing rod holder is particularly suited for ice fishing because it may be placed directly adjacent a hole with the rod tip extending over the hole, although the fishing rod holder may be used in a variety of different types of fishing such as by being placed on a shore adjacent a running river, a lake, an ocean or other body of water.

One advantage of the rod holder of the present invention is that the rod can be pulled straight up out of the rod holder, rather than requiring the rod to be pulled out of a tube or coiled wire. Another advantage of the rod holder is that by placing the rod in the rod holder it is possible to stabilize the rod, whereas if the angler is cold and has shaking hands it can be difficult to detect the subtle movement of the end of the rod by a striking fish.

Yet another advantage of the rod holder of the present invention is that it provides a stable, resettable position on which the rod may rest, such that the angler can always return the rod to the same position after discerning the depth of the water and thereby consistently place the angler's lure a desired height within the water above the bottom of the lake, stream or river, for example.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a fishing rod holder of the present invention in an operational position having a fishing rod on the fishing rod holder with an angler thereby watching the tip of the rod and awaiting the strike of a fish;

FIG. 2 is a perspective view of the fishing rod holder of FIG. 1 in an operational position without the fishing rod therein;

FIG. 3 is a view of the rod holder of FIG. 1 with the first and second upstanding members thereof in a storage position;

FIG. 4 is a perspective view of the fishing rod holder of FIG. 1 with the upstanding members and the stabilizing members shown in a storage position;

FIG. 5 is a top view of the fishing rod holder in the storage position of FIG. 4;

FIG. 6 is a side view of the fishing rod holder in the storage position of FIG. 4 from a side view with the opposing side being the mirror image thereof; positions of the upstanding members having angles α, β at which the self closing hinges cause the upstanding members to close and remain closed against the base are shown in a phantom view.

FIG. 7 is a top view of the fishing rod holder of FIG. 1 as shown in the operational position of FIGS. 1 and 2;

FIG. 8 is a side view of the fishing rod holder of FIG. 1 as shown in the operational position of FIGS. 1, 2 and 7, with the opposing side being the mirror image thereof; an optional additional upstanding member 14′ that forms a replacement member for a kit of the present invention is illustrated in a schematic view in FIG. 8.

FIG. 9 is a view of the operational fishing rod holder of FIG. 1 shown from a bottom view with spikes shown in phantom lines;

FIG. 10 is a view of the operational fishing rod holder of FIG. 1 as shown from a front view;

FIG. 11 is a view of the operational fishing rod holder as shown in FIG. 1 shown in a rear view;

FIG. 12 illustrates the rod holder of FIG. 1 with the front upstanding member rotated toward a downward position such that the rod tip is more shielded from the elements such as wind that may shake the rod, simulating a false strike and potentially confusing the angler;

FIG. 13 illustrates a possible embodiment of a hinge for one or both of the upstanding members of the present invention, illustrating an example of a position retainer configured to retain a selected position of an upstanding member unless sufficient force is generated by the angler (e.g., by pressing against the member with the user's hand) to move the upstanding member to a desired position.

### DETAILED DESCRIPTION OF THE PREFERRED EMBODIMENTS

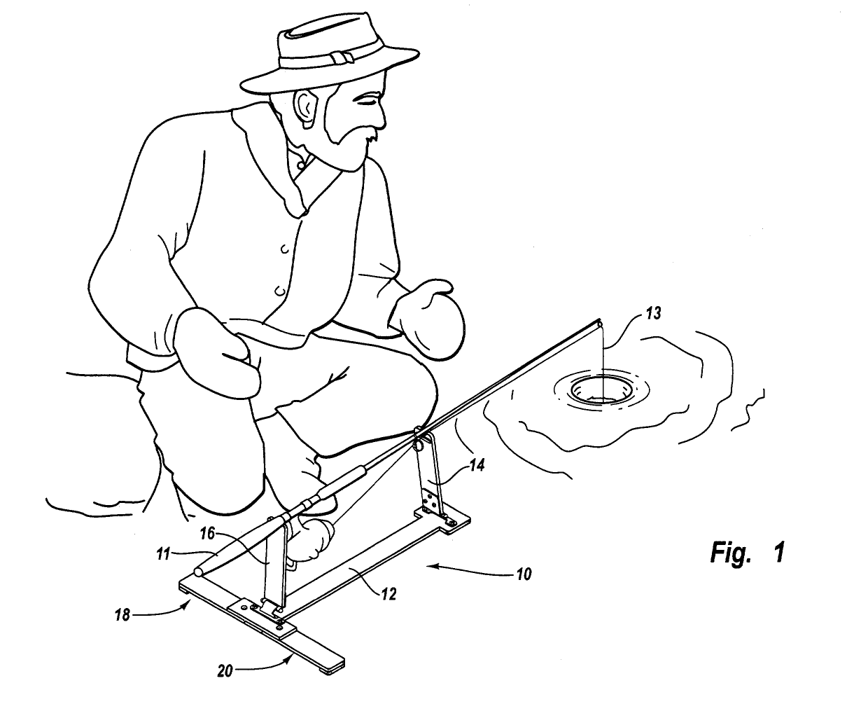

As shown in FIG. 1, a fishing rod holder 10 of the present invention comprises a base 12, a first upstanding member 14 pivotally coupled to the base and a second upstanding member 16 pivotally coupled to an opposing portion of the base 12 such that an angler can place a fishing rod 11 onto the first and second upstanding members 14, 16 then readily remove the fishing rod 11 from the upstanding members 14, 16 when a fish strikes a fishing lure coupled to a line extending from the fishing rod.

Also as shown, stabilizing members 18, 20 extend from the base member 12 so as to provide extra stability for the base member 12 on a slippery surface such as ice.

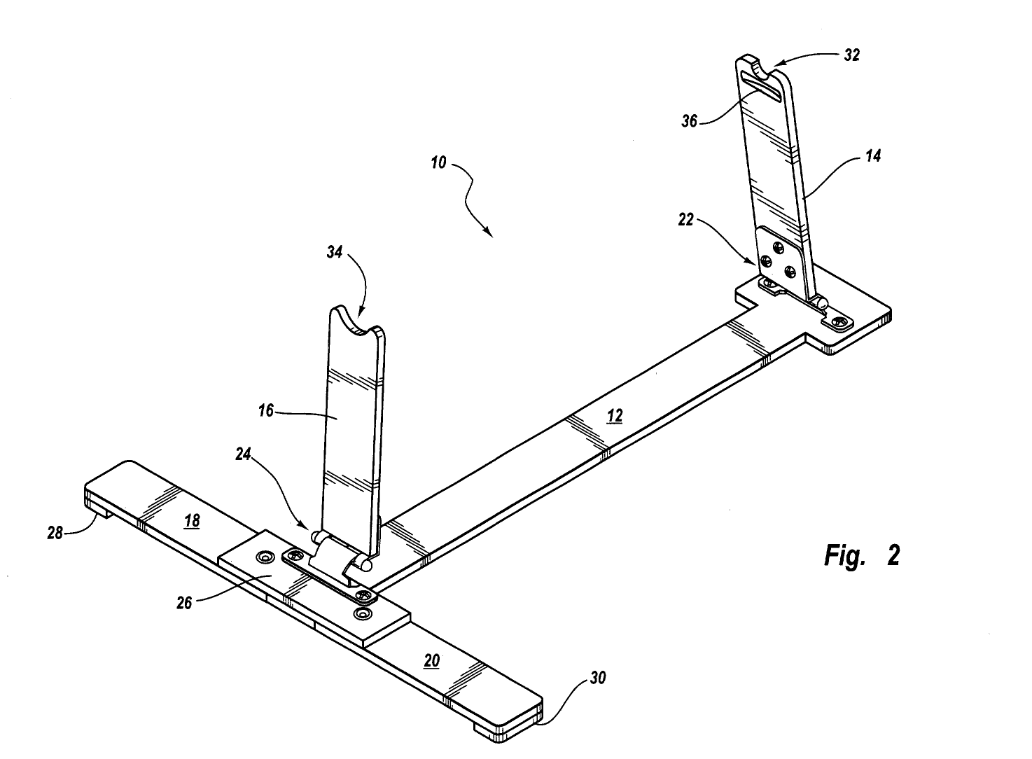

As shown in FIG. 2, fishing rod 11 is conveniently mounted onto the first and second upstanding members 14, 16 by being placed into respective notches 32, 34 (FIG. 2) in respective first and second upstanding members. Upon sensing a strike, for example by noticing movement at the tip of the rod 11, the angler can readily remove the fishing rod 11 from the fishing rod holder 10 by merely picking the fishing rod 11 up. This enables the angler to quickly set the hook without encumbrance from the fishing rod holder 10.

The fishing rod holder 10 of FIG. 1 is further shown in FIG. 2. As shown, a cross member 26 is coupled to base member 12 and has stabilizing members 18, 20 coupled thereto. Each of stabilizing members 18, 20 comprises an elongate member pivotally coupled to the cross member 26 and having a respective extension member 28, 30 coupled thereto such that the stabilizing members 18, 20 each contact the ice surface or other surface to thereby stabilize the rod holder 10.

Notches 32 and 34 are shown in corresponding upstanding members 14, 16. These notches can receive portions of the fishing pole and cradle the pole therein. In one embodiment, the notches 32, 34 are configured such that when a fish strikes and pulls on the fishing line, the rod presses against the upstanding members, but does not slip out of the notches. Nevertheless, upon receiving a strike, the angler can readily remove the fishing pole from rod holder 10.

Rear notch 34 is preferably larger than front notch 32 in order to retain handle 34 therein. Front notch 32 may be configured to prevent an eylet or other portion of rod from moving past member 14 (see FIG. 1). Rear notch 34 may be similarly configured to prevent handle from moving past member 16, e.g. by contacting a portion of the handle of a rod. Notches 32, 34 may have a variety of different sizes. In one embodiment, notch 32 is the front notch and holds a front portion of the rod and has a length of less than about ¾ inch (e.g., has a length of about ½ inch) across while notch 34 is a back notch and holds the rod handle and has a length of more than about 3/4 inch (e.g., has a length of about 1 inch to about 11/4 inch) across, although a variety of sizes are available.

Upstanding members 14, 16 may be sufficiently rigidly connected to base member 12 that the strike of the fish will not cause the rod to be moved off of the holder 10. In one embodiment, however, the purpose of the rod holder is not necessarily to prevent the rod from moving, but rather to allow the fisherman to elevate the rod above a surface, such as an ice surface, such that movement of the rod tip can be readily observed such that the fishing rod can be readily grasped upon noticing such rod tip movement or other sign of a strike.

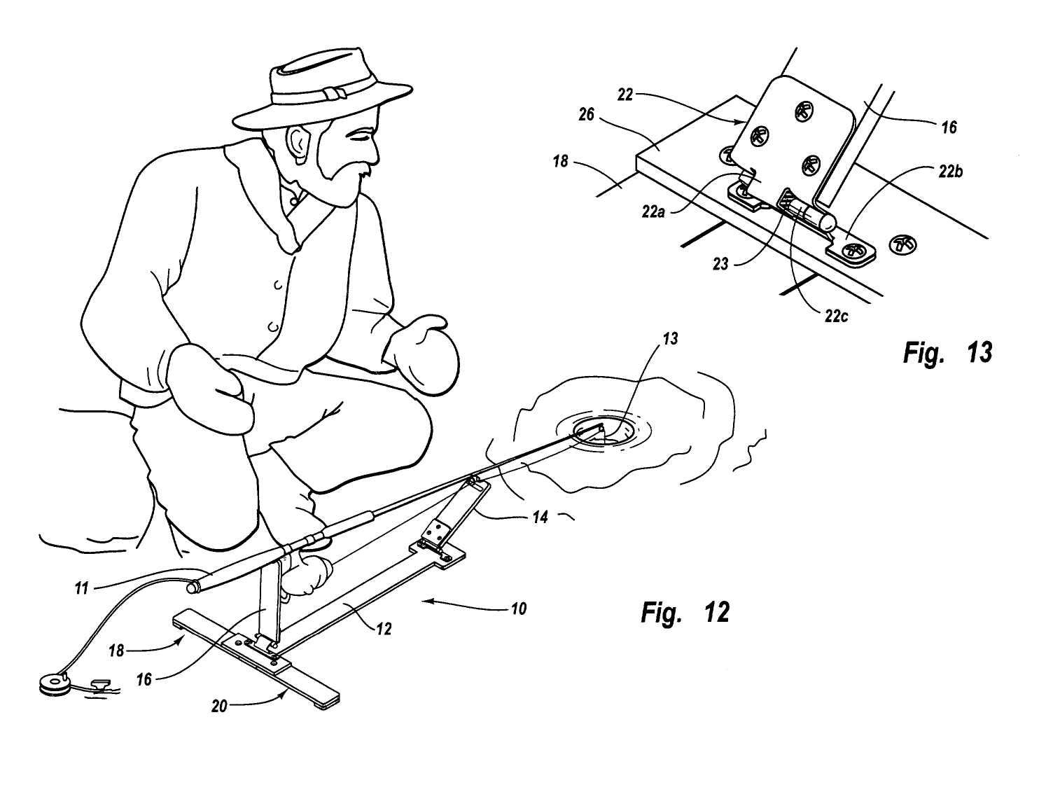

Optionally, or in addition, slit 36 may be made in one or more of members 14, 16 so that when the member is bent downwardly an eyelet of the fishing rod may be inserted into the slit 36 to thereby retain the eyelet therein (see e.g., FIG. 12).

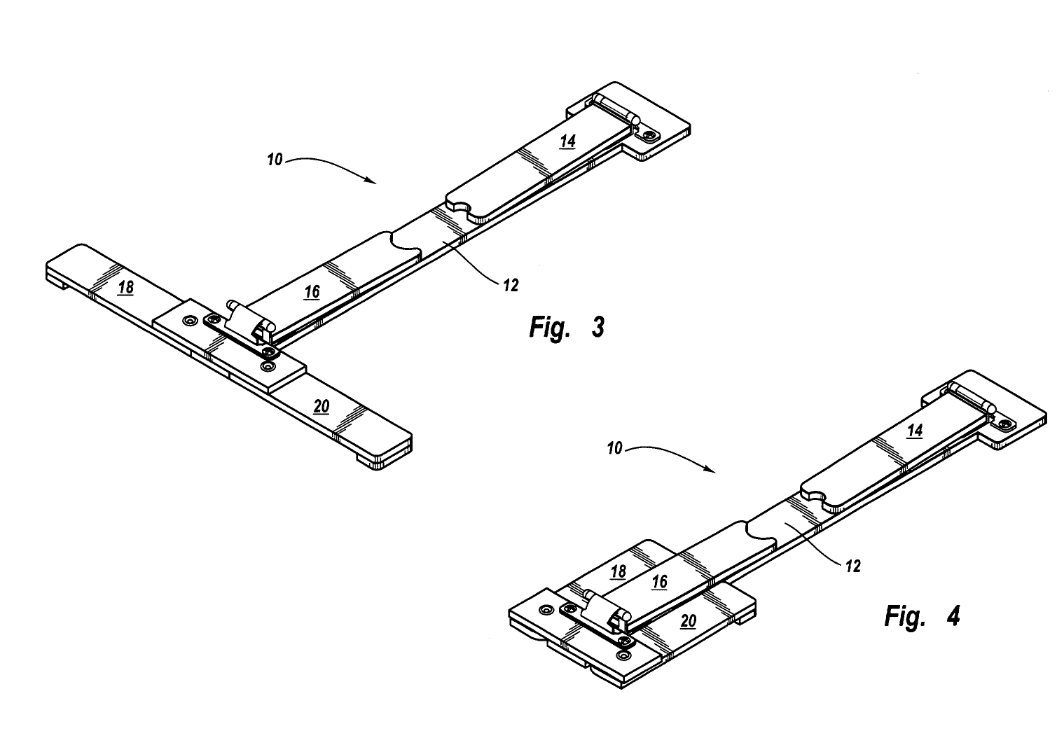

In one embodiment, members 14, 16 are pivotally coupled to member 12 through the use of respective self-closing hinges 22, 24 e.g., spring loaded, self-closing, position-retaining cabinet hinges, such that upon movement of the upstanding members past a certain angle toward the base member (see e.g., angles α, β FIG. 6), the members 14, 16 snap into the storage position shown in FIG. 3, in which upstanding members 14, 16 are shown in a storage position.

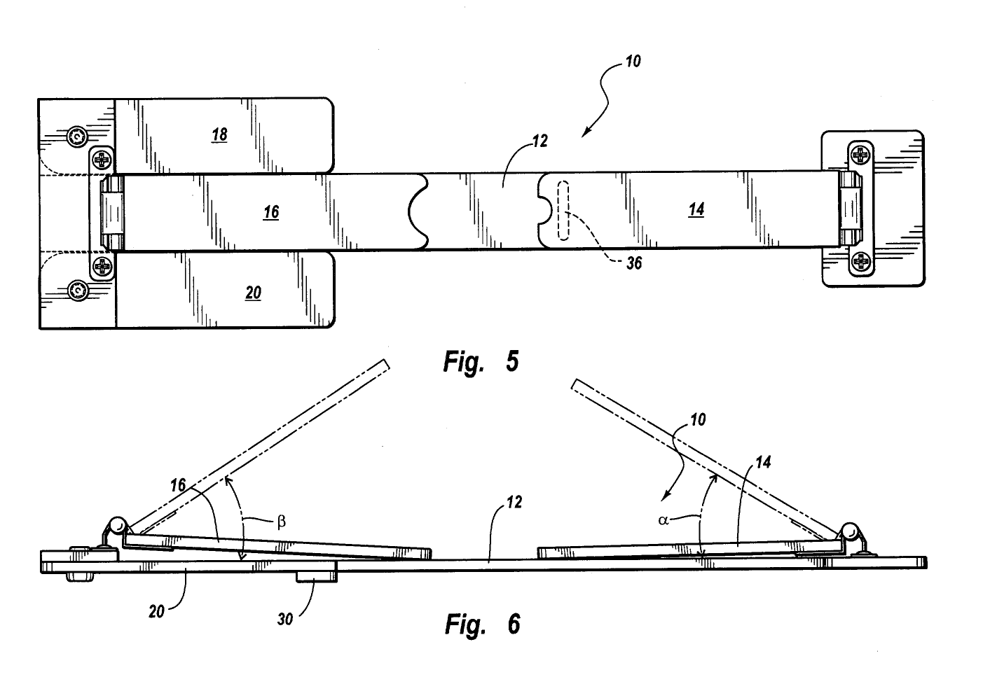

FIG. 4 demonstrates each of the members 14, 16, 18 and 20 in the storage position demonstrating the convenience of the device which readily allows the rod holder 10 to be placed into the pocket, bag, pack, box, or other container used by an angler. The top view of the rod holder 10 is shown in FIG. 5.

FIG. 6 demonstrates the thin storage profile that may be achieved through the use of the pivoting members. In one embodiment, the pivotal coupling enabled through the self closing hinges of the present invention is such that the upstanding members may be adjusted into and retained in a desired upstanding position until reaching angles α, β (e.g., of approximately 20 degrees to approximately 50 degrees for each angle β, β) above the base, after which they snap into the storage position. The upstanding members are retained in the storage position of FIG. 6 (non-phantom lines) until a force is generated to move the upstanding members back past the angles angles α, β into positions in which the upstanding members are retained in the selected angle by a retaining portion of the hinges.

In one embodiment, angles α, β are less than 90 degrees, e.g., less than 75 degrees or less than 50 degrees, e.g. about 25 to about 45 degrees, or about 30 to about 40 degrees.

The base and each upstanding member has a portion of a respective hinge 22, 24 coupled thereto. The respective hinge portions may be injection molded integrally with the respective upstanding member and/or base plate, for example. A threaded axle and nut may be employed to selectively connect the molded hinge portions. For example, in one embodment, the molded upstanding member/hinge portions are retained at a desired angle through the use of a threaded axle and a nut (e.g., a wing nut or other nut connected to a handle) that is tightened sufficiently to retain the upstanding member/hinge portion in a selected angle with respect to the base.

FIG. 7 further demonstrates the sleek design and function of the stabilizing members 18, 20.

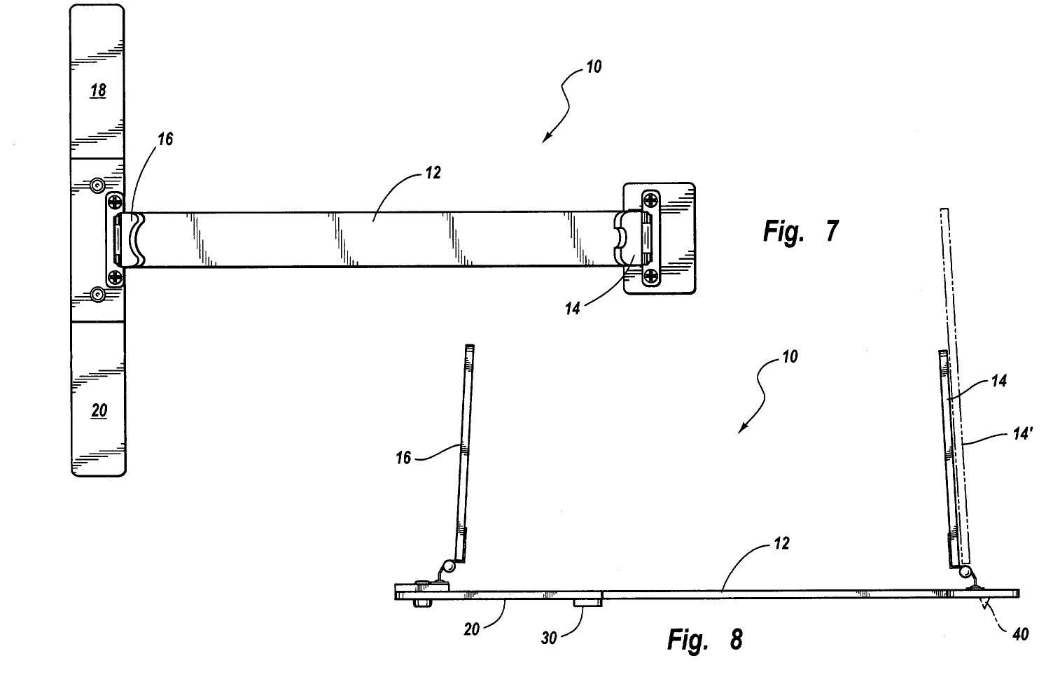

Also featured in a schematic view in FIG. 8 is an example of a possible optional upstanding member 14′ that may be included in a kit comprising the rod holder 10 with an optional taller upstanding member 14′ so that an angler can further adjust the angle of inclination of the fishing rod (e.g., angle the rod significantly with the taller member 14′ toward the river so that the rod tip extends high into the air during bank fishing) by employing a significantly larger upstanding member.

Member 14′ can optionally replace member 14 or member 16 if a larger upstanding member is desired by decoupling member 14 or 16 from base 12, then coupling member 14′ to the base in its place. This selective decoupling and coupling may occur through the use of hinge portions on member 14′ and members 14 or 16 that can be selectively coupled and decoupled from base 12.

Thus, in one embodiment, the hinge portions that collectively form the hinges are selectively coupled to each other, in order to make replacement of upstanding members convenient. This may be achieved, for example, through the use of threaded pin extending through mating hinge portions, the threaded pin being selectively coupled to a corresponding nut, such as a wing nut or other nut having a handle thereon such that the hinge portions may be selectively coupled together. The nut/thread may also be configured such that tightening of the nut causes the upstanding member to be locked in a desired position with respect to the base.

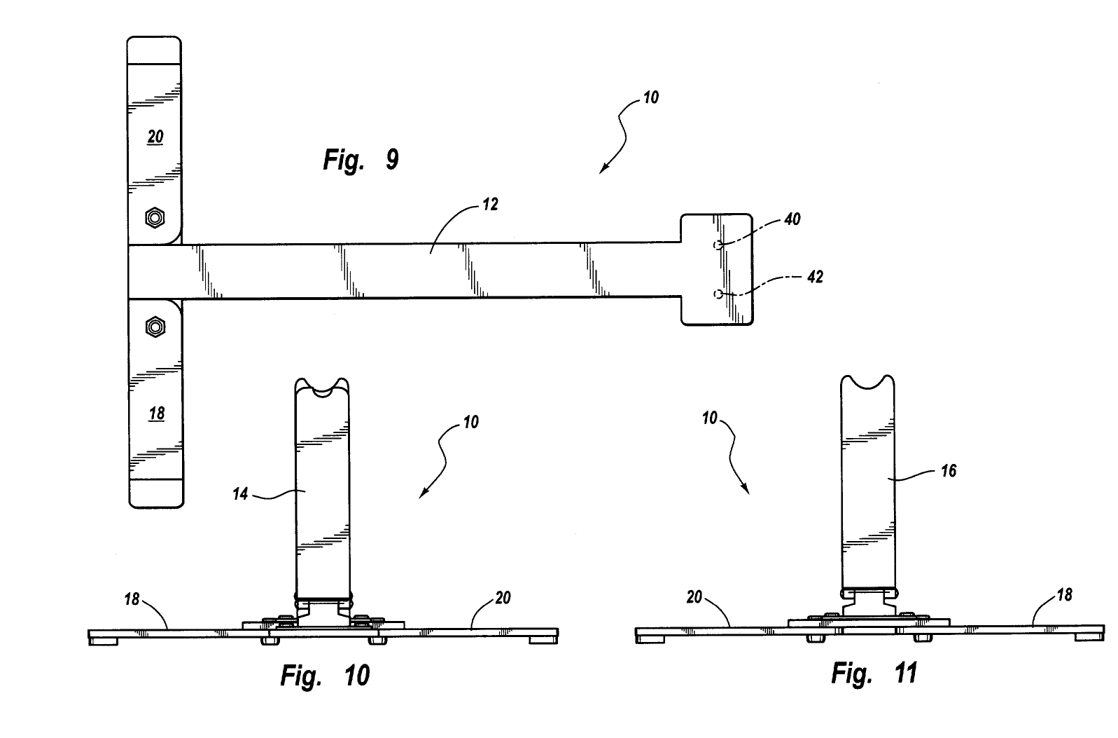

In one embodiment such as shown in FIG. 9 which features the underside of rod holder 10, one or more spikes 40, 42 are shown in phantom lines. These one or more spikes 40, 42 may be employed in order to prevent the rod holder 10 from sliding along the ice and may protrude downwardly sufficient so as to grasp a slippery surface such as ice. Such one or more spikes may also be mounted on the rear portion of the rod holder 10.

FIGS. 10 and 11 further show respective front and rear views of rod holder 10 demonstrating the sleek efficient design and functionality of the device.

FIG. 12 illustrates the rod holder of FIG. 1 with the front upstanding member rotated toward a downward position such that the rod tip is more shielded from the elements such as wind that my shake the rod, simulating a false strike and potentially confusing the angler. As shown in FIG. 12, the rod tip can be moved downwardly when at least one of the upstanding members is angled, such that the rod tip can be more protected from the effects of wind.

FIG. 13 illustrates the positioning retaining hinge 22 employed in an embodiment of the present invention. Hinge 22 comprises a first portion 22a that is coupled to upstanding member 14 and a corresponding second portion 22b that is affixed to base 12. As shown, a retainer 23 (comprising for example, a plastic or elastomeric material) is affixed to first portion 22a of hinge 22. Retainer 23 contacts the cylindrically shaped portion 22c of second hinge portion 22b and through friction causes hinge portion 22a to remain in a fixed position until sufficient force is generated to move the hinge portion 22a with respect to hinge portion 22b. Such force may be movement by a hand of an angler, for example. Hinge 24 may be constructed similarly to or the same as hinge 22, for example.

The hinges 22, 24, thus retain the upstanding members in a desired angled position even with the rod thereon until additional force is added thereto, or until the upstanding members are moved to closing angle α, β (FIG. 6). As discussed above, in one embodiment spring loaded cabinet hinges are employed such that upon reaching a certain angle of inclination, the upstanding member snaps into the compact storage position. For example, in one embodiment upon reaching approximately a desired angle selected by an angler the upstanding member snaps into the compact storage position.

In another embodiment, the desired retained position can be achieved through the use a nut and a corresponding screw extending through mating upstanding member and base hinge portions, with the nut being tightened to retain the upstanding member in the desired postion when the desired angle of inclination is achieved.

One significant advantage of the rod holder of the present invention is that it provides a repeatable position that the fishing rod can be placed in. One advantage to repeatedly placing the rod tip adjacent the surface of the water as shown in FIG. 1 or 12 is that such placement can provides helps that angler consistently (i) establish where the bottom of the lake or other body of water is; and (ii) place his or her rod there.

For example, once the angler finds the bottom by releasing 100 feet of line with the rod tip one inch above the surface of the water, the angler can find the bottom again by releasing the same amount of line and by placing the rod tip in the same rod tip position. This is very useful for anglers who identify schools of fish at a certain depth, such as a few feet from the bottom, for example.

The upstanding members may have a variety of different shapes and configurations, any of which may be useful in achieving the function of the present invention such as thinner members, members made of a dowel, rod, stick or wire, or a variety of other structures, any of which may be sufficiently rigid to hold a fishing rod above a surface. For example, front stabilizing members similar to rear stabilizing members 18, 20 may be employed.

In one embodiment, at least the primary parts of the fishing rod holder are configured to be injection or insertion molded. For example, in one embodiment, a hinge portion is injection molded integrally with a respective upstanding member, then pivotally linked with a base member having respective hinge portions injection molded therewith. The two parts can then be linked through the use of an axle. The resulting hinge may be a resistance hinge, for example, with an associated adjustable wing nut or similar mechanism such that it is possible to adjust and selectively retain the hinge, base and upstanding members into a desired angled position with respect to each other (similar to the use of hinge 22 of FIG. 13) by threading and unthreading the adjustable nut.

The base, upstanding and stabilizing members may be comprised of a variety of different materials, such as wood (e.g., with a verithane finish), metal (e.g., aluminum) or plastic (e.g., ABS or injected polycarbonate), or other elastic material eg. rubber, any of which may be suitable for manufacturing and using the present invention. The hinges may be comprised of stainless steel, for example.

In yet another embodiment, as illustrated in FIG. 12, a lanyard is connected to the fishing rod at one end and secured to the ground, ice, or wrist of the angler, for example (e.g, with an ice stake) or to the rod holder 10 itself such that a massive strike will not drag the fishing rod into the lake or river. Such a lanyard may comprise a retractable lanyard, for example, but is preferably designed so as not to interfere with movement of the rod out of the rod holder when a strike is detected.

As shown in all of the views shown herein, the rod holder also has a sleek appealing design that may be desirable for anglers during display and use.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fishing rod holder comprising
a base,
a first upstanding member pivotally coupled to the base; and
a second upstanding member pivotally coupled to an opposing portion of the base such that an angler can place a fishing rod onto the first and second members, then readily remove the fishing rod from the upstanding members when a fish strikes a fishing line coupled to the fishing rod.

2. A fishing rod holder as recited in claim 1, wherein each upstanding members has a notch therein.

3. A fishing rod holder as recited in claim 2, wherein a first notch is smaller in length than the second notch.

4. A holder as recited in claim 3, wherein the first notch has a length of less than about ¾ inch and the second notch has a length of more than about ¼ inch.

5. A fishing rod holder as recited in claim 1, wherein each of the members is selectively orientable between a operational position and a storage position.

6. A fishing rod holder as recited in claim 1, further comprising first and second stabilizing members coupled to the base member.

7. A fishing rod holder as recited in claim 1, wherein each of the upstanding members is configured to be selectively oriented perpendicular or parallel to the base member or any point therebetween.

8. A fishing rod holder as recited in claim 1, wherein at least one of the members has a slit on an inside portion thereof.

9. A fishing rod holder as recited in claim 1, wherein the first and second upstanding members snap onto the base member.

10. A fishing rod holder as recited in claim 1, further comprising a mechanism coupled to the base member for preventing the base member from sliding along an ice surface.

11. A fishing rod holder as recited in claim 1, wherein the mechanism for preventing the base from slipping across an ice surface comprises first and second spikes placed in the base member.

12. A fishing rod holder as recited in claim 1, wherein at least on the first and second upstanding members can be selectively angled with respect to the base in such a manner that the upstanding member retains the selected position.

13. A fishing rod holder as recited in claim 1, wherein at least one of the first and second upstanding members is pivotally coupled to the base through the use of a self-closing hinge.

14. A fishing rod holder as recited in claim 1, wherein the base comprises an elongate plate and the first and second upstanding members each comprise an elongate plate.

15. A fishing rod holder comprising
a base,
a first upstanding member pivotally coupled to the base;
a second upstanding member pivotally coupled to an opposing portion of the base such that an angler can place a fishing rod onto the first and second members, then readily remove the fishing rod from the upstanding members when a fish strikes a fishing line coupled to the fishing rod;
a first stabilizing member extending from one side of the base; and
a second stabilizing member extending from an opposing side of the base, wherein the first and second upstanding members are pivotally coupled to the base in such a manner that the user can selectively orient the upstanding members in a desired position with respect to the base.

16. A fishing rod holder as recited in claim 15, wherein the first and second upstanding member snap into a compact storage position upon being placed into a desired angle with respect to the base.

17. A fishing rod holder as recited in claim 15 wherein the desired angle is less than 75 degrees.

18. A fishing rod holder kit comprising
A fishing rod holder comprising:
a base,
a first upstanding member pivotally coupled to the base;
a second upstanding member pivotally coupled to an opposing portion of the base such that an angler can place a fishing rod onto the first and second members, then readily remove the fishing rod from the upstanding members when a fish strikes a fishing line coupled to the fishing rod;
a first stabilizing member extending from one side of the base; and
a second stabilizing member extending from an opposing side of the base, wherein the first and second upstanding members are pivotally coupled to the base in such a manner that the user can selectively orient the upstanding members in a desired position with respect to the base; and
a third upstanding member having a height that is different from either the first or second upstanding member and can be selectively mounted onto the base in the place of at least one of the first and second upstanding members.

19. A fishing rod holder kit comprising
A fishing rod holder comprising:
a base,
a first upstanding member pivotally coupled to the base;
a second upstanding member pivotally coupled to the base such that an angler can place a fishing rod onto the first and second members, then readily remove the fishing rod from the upstanding members when a fish strikes a fishing line coupled to the fishing rod; and
a lanyard configured to be coupled to the fishing rod.

20. A kit as recited in claim 20, wherein the lanyard is configured to be coupled to the fishing rod at one end of the lanyard and to the ice at an opposing end of the lanyard.
